(19) United States
(12) Patent Application Publication
(10) Pub. No.: US 2009/0215915 A1
(43) Pub. Date: Aug. 27, 2009

(54) Flame retardant composition and polyurethane foams containing same

(76) Inventors: Danielle A. Bright, New York, NY (US); Leslie Bright, New City, NY (US); Barbara A. Williams, New York, NY (US); Emanuel Pinzoni, Hawthorne, NJ (US); Edward D. Weil, Copley, OH (US)

Correspondence Address: DILWORTH & BARRESE, LLP, 1000 WOODBURY ROAD, SUITE 405, WOODBURY, NY, 11797, US

(21) Appl. No.: 11/919,848

(22) PCT Filed: May 3, 2006
(86) PCT No.: PCT/US06/16997

§ 371 Date: Feb. 17, 2009

Related U.S. Application Data
(60) Provisional application No. 60/677,792, filed on May 4, 2005.

(51) Int. Cl. C09K 21/14; C09K 21/12

(52) U.S. Cl. 521/107; 252/609

(57) ABSTRACT

The present invention relates to flame-retardant compositions for use in polyurethane foams, the flame-retardant composition comprising: (a) a phosphate ester blend comprising triphenyl phosphate and one or more alkyl-substituted triphenyl phosphates; and (b) a polyol crosslinking agent soluble in the phosphate ester blend. The invention also relates to flexible polyurethane foams containing these flame-retardant compositions.

This application claims the priority benefit of U.S. Provisional Application Serial No. 60/677,792 filed May 4, 2005, the entire contents of which are incorporated by reference herein.

### FIELD OF THE INVENTION

The present invention relates to flame retardant compositions, and more particularly to liquid phosphate ester flame retardant compositions for use in polyurethane foams.

### BACKGROUND OF THE INVENTION

Flexible polyurethane foams are widely used as cushioning or padding materials, for example, in furniture, mattresses, automobiles, etc. Flame-retardants are generally incorporated into the foams. However, it is difficult to find a flame-retardant that will achieve adequate flame retardancy economically and without impacting negatively on the physical properties of the foams.

The flame retardants used by the flexible slab industry in the U.S. are primarily intended to meet two flammability tests. These are the MVSS302 test used by the automotive industry and the California Bureau of Home Furnishings 117A&D (actually a combination of 2 tests). Aryl phosphates are known to meet these requirements, however, at the levels necessary to achieve adequate flame retardancy they have a tendency to deleteriously soften the foams (especially the low density foams) to the extent that physical properties, such as compression set, do not meet commercially acceptable standards. For example, butylated triphenyl phosphate (known in the art to be a blend of triphenyl phosphate and one or more butyl-substituted triphenyl phosphates) is a particularly effective flame retardant. However, its use tends to soften the foam.

Much literature is known relating to flame retardancy and/or improving the physical properties of polyurethane foams. For example, U.S. Pat. No. 6,855,741 discloses an improved flexible polyurethane foam produced by the reaction of a composition containing a polyol, an isocyanate, a non-halogen foaming agent, a plasticizer selected from alkyl benzyl phthalates, phosphate esters and benzoates, and a crosslinker/extender such as resorcinol and polyoxyalkylene polyol. This patent relates to softening polyurethane foams, that have been hardened by the use of water as a blowing agent, by the incorporation of plasticizers, such as phthalates or phosphate esters, in the foam. It does not relate to the “hardening” of foams, which are softened by the incorporation of aryl phosphate ester flame retardants in the foams, in order to maintain the acceptable physical properties of the foams.

Thus, there remains a need to provide means to maintain the acceptable physical properties of polyurethane foams which tend to be softened by the incorporation of aryl phosphate ester flame retardants.

### SUMMARY OF THE INVENTION

In accordance with the present invention, these and other objectives are achieved by providing a liquid flame retardant composition comprising:
(a) a phosphate ester blend comprising triphenyl phosphate and an alkyl-substituted triphenyl phosphate; and
(b) a polyol crosslinking agent soluble in said phosphate ester blend (a).

Further in accordance with the present invention, polyurethane foams are provided incorporating flame retardant effective amounts of the foregoing liquid flame retardant.

It has been surprisingly found herein that the use of a flame-retardant phosphate ester blend comprising triphenyl phosphate and an alkyl-substituted triphenyl phosphate mixed with a polyol crosslinking agent, when incorporated into a polyurethane foam, not only provides a foam that can pass the flammability test, but also provides a foam having acceptable physical properties, such as compression set properties, similar to foams not containing the phosphate ester flame retardant.

### DETAILED DESCRIPTION OF THE INVENTION

The liquid flame retardant composition of the present invention comprises a blend of triphenyl phosphate and one or more alkyl-substituted triphenyl phosphates in combination with a polyol crosslinking agent. The alkyl-substituted triphenyl phosphates present in the blend can be mono-, di-, and/or tri-alkyl substituted triphenylphosphates having straight-chained and/or branched alkyl groups, preferably C₁ to C₄ alkyl groups, bound to a same or different phenyl ring. The alkyl group(s) can be independently bound to the o-, m-, or p- positions of the phenyl rings.

Representative phosphate ester flame retardant blends useful in the practice of the present invention include, for example, triphenyl phosphate and alkyl-substituted triphenyl phosphates, such as cresyldiphenyl phosphate, ethylphenyldiphenylphosphate, diethylphenyldiphenylphosphate, n-propylphenyldiphenylphosphate, isopropylphenyldiphenylphosphate, diisopropylphenyldiphenylphosphate, n-butylphenyl diphenylphosphate, isobutylphenyldiphenylphosphate, t-butylphenyldiphenylphosphate, dicresylphenylphosphate, bis-(ethylphenyl)phenylphosphate, bis-(isopropylphenyl)phenyl phosphate, bis-(t-butylphenyl)phenylphosphate, tricresylphosphate, tris-(ethylphenyl) phosphate, tris-(isopropylphenyl)phosphate, tris-(t-butylphenyl)phosphate and mixtures thereof.

The flame retardant phosphate ester blends of the present invention preferably comprise about 20 percent or more, typically from about 20 to about 80 percent, by weight, of the triphenyl phosphate component and typically from about 80 to about 20 percent, by weight, of alkyl-substituted triphenyl phosphate, based on the total weight of the phosphate ester blend. Alternatively, the flame retardant phosphate ester blend useful in the practice of the present invention preferably has a total phosphorus content of at least about 8.3 percent, by weight, phosphorus, and more preferably at least about 8.5 percent, by weight, phosphorus.

In a preferred embodiment of the invention, the phosphate ester blend is butylated triphenyl phosphate, i.e., a blend of triphenyl phosphate with one or more t-butyl-substituted triphenyl phosphates. A particularly preferred butylated triphenyl phosphate is commercially available from Supresta, LLC, known as Phosflex 71B.

The phosphate ester flame retardant composition of the present invention comprises from about 90-99%, preferably 94-99%, by weight, of the phosphate ester blend and 1-10%, preferably 1-6%, by weight, of polyol crosslinking agent, based on the total weight of the composition. The composition is typically prepared by mixing the phosphate ester blend with the polyol, usually at room temperature to about 50° C.

The polyol crosslinking agents used in accordance with the present invention can be solid or liquid and generally can be any polyol crosslinking agents known in the art which are soluble in the phosphate ester blend. Such crosslinking agents include, for example, polyether-polyols, polyester-polyols, branched derivatives of the foregoing (derived from, e.g., glycerine, sorbitol, xylitol, mannitol, glucosides, 1,3,5-trihydroxybenzene) and the like. Preferred polyol crosslinking agents are the trifunctional or higher functional polyols.

For the purposes of the present invention, polyester-polyols are particularly preferred. Representative classes of suitable polyester-polyols include, for example, orthophthalate-based, ethylene glycol-based, and diethylene glycol-based aromatic and aliphatic polyester-polyols.

The polyol crosslinking agents useful herein typically have hydroxyl values ranging from about 25 to about 500, preferably about 50 to about 250, and more preferably about 50 to about 150. Representative polyol crosslinking agents useful in the practice of the present invention, including the preferred polyester-polyols, are recited in Table 1 below.

In another embodiment, the invention relates to flexible polyurethane foams incorporating a flame retardant effective amount of any of the foregoing described phosphate ester flame retardant compositions. Typically, the phosphate ester flame retardant composition is included in the polyurethane foam in amounts ranging from about 5 to 25, and preferably 10 to 20 parts per hundred parts (pphp) of base polyol used to make the foam.

Preferably, the base composition of the polyurethane foam includes any one or more of the base polyol components known in the art for making polyurethane foams in combination with a toluene diisocyanate (TDI) component, as known in the art for making flexible polyurethane foams.

The polyurethane foams incorporating the phosphate ester flame retardant blends generally have densities ranging from 1.0 to 2.0 pounds per cubic foot (pcf).

### Polyurethane Foam Forming Procedure

In a typical procedure, the polyol, flame-retardant(s), water, amine catalyst and silicone surfactant are mixed, with stirring, in a first beaker. In a separate beaker, the toluene diisocyanate (TDI) is weighed out. The organo-tin catalyst is placed in a syringe. The first beaker is stirred at 2100 revolutions per minute for a period of ten seconds and the organo-tin catalyst is then dosed thereto while stirring is continued. After a total of about twenty seconds of stirring, the TDI is added to the mixture. Stirring is then continued for about an additional ten seconds, the still-fluid mixture quickly placed into a 16 inch×16 inch×5 inch box, and the cream and rise time measured. Once the foam ceases to rise, the foam is placed in an oven at 70° C. for about twenty minutes to cure.

A particularly preferred formulation for flexible polyurethane foams according to the invention is provided below.

Typical Foam Formulation (1.0 pcf) (pounds per cubic foot)

| Ingredient | Parts |
|---|---|
| Polyether Polyol | 100 |
| H₂O | 5.6 |
| Phosphate Ester FR blend* | 18-20 |
| Amine Blend | 0.25 |
| Niax ®L620 | 1.0 |
| Stannous Octoate | 0.55 |
| TDI 80/20 | 71.2 |
| TDI index | 110 |

*Phosphate ester blend plus polyol crosslinker

Other additives can be included, such as, for example, colorants, dyes, fillers, antioxidants, and anti-static agents, all of which are commonly used in the art.

### Test Methods

The following standard tests were employed:

### A. Test D Constant Deflection Compression Set Test (CT90)

Summary of Test Method—This test method consists of deflecting the foam specimen under specified conditions of time and temperature and noting the effect on the thickness of the specimen.
Apparatus—The apparatus consists of two or more plates arranged so the plates are held parallel to each other by bolts or clamps and the space between the plates is adjustable to the required deflection thickness by means of spacers.

Test Specimens—The test specimen shall have parallel top and bottom surfaces and essentially perpendicular sides. Three specimens per sample shall be tested. If any value deviates more than 20% from the median, two additional specimens shall be tested and the median for all five values shall be reported.

### Procedure

1. Conduct all measurements at 23° C.+/−2° C. in a 50% relative humidity atmosphere. The oven shall be at 70° C.+/−2° C.

2. Measure the thickness up to and including 25 mm using a dial-type gage.

3. Place the test specimens in the apparatus and deflect it to either 50+/−1, 75+/−1, or 90+/−1 % of its thickness.

4. Within 15 minutes place the deflected specimen and the apparatus in the mechanically convected air oven for 22 hours; then remove the apparatus.

5. Remove the specimen immediately from the apparatus and measure it in accordance with the dial gage 30 to 40 minutes after recovery.

6. Calculate the compression set values expressed as a percentage of the original thickness minus the final thickness of test specimen divided by the original thickness.

### B. Test B₁ Indentation Force Deflection (IFD) (Specified Deflection)

Summary of Test Method—This is known as the indentation force deflection test and the results of the IFD values that consist of measuring the force necessary to produce 25% or other designated indentations in the foam product.
Apparatus—An apparatus having a flat circular indentor foot 323 cm ² in area connected by means of a swivel joint capable of accommodating the angle of the sample to a force measuring device and mounted in such a manner that the product or specimen can be deflected at a speed of 0.4 to 6.3 mm/s. The apparatus shall be arranged to support the specimens on a level horizontal plate.
Test Specimens—The test specimen shall consists of the entire product sample or a suitable portion of it, except that in no case shall the specimen have dimensions less than 380 by 380 by 20 mm. One specimen shall be tested.

### Procedure

7. Place the test specimen in a position on the supporting plate of the apparatus. The specimen shall be placed that the indentor foot is in the center of the foam.

8. Preflex the area to be tested by twice lowering the indentor foot to a total deflection of 25% of the full part of the thickness. Mark the location of the test area with a pen by circumscribing the indentor foot. Allow the specimen to rest 6+/- minutes after the preflex.

9. Bring the indentor foot into contact with the specimen and determine the thickness after applying a contact force to the indentor foot. Indent the specimen to 25% of this thickness and observe the force in newtons after 60 seconds. This is the IFD value.

### C. Cal.TB 117 A Test:

This test is a small-scale vertical test with a twelve-second-ignition time. The sample size was 12″×3×½″. The ignition source was removed after twelve seconds. A second clock is started if the sample continues to burn. The criteria for failing included: a sample exceeding an individual bum of eight inches or average burns of six inches. The time criteria required that an individual specimen would not have an individual after flame or afterglow exceeding ten seconds or an average after flame or afterglow exceeding five seconds.

### D. Cal.TB 117 D Test:

This test is a smoldering test in which a cigarette is used as the ignition source under a cotton cloth cover. The foam sample was covered with a standard velvet cotton cloth and was placed in a small wooden frame to form a mock chair. The back of the sample was 8″×7″×2″, and the seat was 8″×4″×2″. The sample was weighed before testing and was again weighed after the test was finished. If the foam lost more than 20% of its weight, it was judged to be a failure.

Butylated triphenyl phosphate blends were used in a variety of foams and tested, either alone or in combination with a polyol, as further described below.

### Results

Results are shown below in Table 1. The data show the improved results obtained in accordance with the present invention. CT90 values of 15 or less are preferred.

TABLE 1
Compression sets and IFD Data for 1.0 pcf foams

| | | Type of product and | | | | |
|---|---|---|---|---|---|---|
| | Flame Retardant⁽¹⁾ | Hydroxyl value (mg · | Solubility in | 24 hr. | | Air Flow |
| Example | (blend ratio) | KOH · g.) | b-TPP | CT90 | IFD | (cfm) |
| 1 | b-TPP* | | NA | 26 | 24 | 5.8 |
| 2 | Fyrol ® FR-2** | | NA | 14 | 25 | 5.8 |
| 3 | Stepanpol PS2352 | Orthophthalate-diethylene | soluble | 15 | 24 | 6 |
| | (97:3) | glycol based aromatic | | | | |
| | (Stepan) | polyester-polyol | | | | |
| | | Hydroxyl value 240 | | | | |
| 4 | Stepanpol PS2352 | Orthophthalate-diethylene | soluble | 15 | 25 | 5.3-5.7 |
| | (98:2) | glycol based aromatic | | | | |
| | (Stepan) | polyester-polyol | | | | |
| | | Hydroxyl value 240 | | | | |
| 5 | Niax DP1022 (97:3) | 1,3-butanediol | soluble | 23 | 29 | 6.2 |
| | (GE) | Hydroxyl value 1200 | | | | |
| 6 | Fomrez 2C53 (95:5) | Glycerine branched | soluble | 13 | 24 | 5.6-5.8 |
| | (Crompton) | diethylene glycol adipate | | | | |
| | | polyester-polyol | | | | |
| | | Hydroxyl value 52 | | | | |
| 7 | Fomrez 2C53 (97:3) | Glycerine branched | soluble | 12 | 26 | 5.5-5.9 |
| | (Crompton) | diethylene glycol adipate | | | | |
| | | polyester-polyol | | | | |
| | | Hydroxyl value 52 | | | | |
| 8 | Fomrez 2C53 (98:2) | Glycerine branched | soluble | 14 | 25 | 5.4-5.6 |
| | (Crompton) | diethylene glycol adipate | | | | |
| | | polyester-polyol | | | | |
| | | Hydroxyl value 52 | | | | |
| 9 | Niax FH 200 (97:3) | Polyester-polyol/solvent | soluble | 15 | 26 | 5.5 |
| | (GE) | mixture | | | | |
| | | Hydroxyl value 150-160 | | | | |
| 10 | Niax FH 200 (95:5) | Polyester-polyol/solvent | soluble | 14 | 29 | 5.5 |
| | (GE) | mixture | | | | |
| | | Hydroxyl value 150-160 | | | | |
| 11 | trimethylol propane | Aliphatic triol | soluble | Failed | 27 | 6.0 |
| | (95/5) | Hydroxyl value 1255 | | | | |
| 12 | triethanolamine | | soluble | Failed | | 3.8-5.6 |
| 13 | Voranol 230 (95/5) | Polyether polyol | soluble | Failed | | 5.7-6.1 |
| | (Dow) | Hydroxyl value 106-119 | | | | |
| 14 | Voranol 230 (97/3) | Polyether polyol | soluble | 20 | | 5.7-5.8 |
| | (Dow) | Hydroxyl value 106-119 | | | | |
| 15 | Bisphenol A (97/3) | Aromatic diol | soluble | 25 | | 5.6-6.1 |
| 16 | Resorcinol (97:3) | Aromatic Diol | soluble | 21 | | 5.7-5.8 |
| | | Hydroxyl value 1018 | | | | |
| 17 | Sorbitol (97:3) | Sugar alcohol | Insoluble | | | |
| | | Hydroxyl value 1845 | | | | |
| 18 | Pentaerythrytol | Aliphatic polyfunctional | Insoluble | | | |
| | (95:5) | alcohol | | | | |
| 20 | Glycerol (95:5) | | Insoluble | | | |
| 21 | Sucrose (95:5) | | Insoluble | | | |
| 22 | Glycerine (95:5) | | Insoluble | | | |

⁽¹⁾Examples 1 and 2 contain only b-TPP and Fyrol FR-2, respectively. All other examples comprise blends of b-TPP with listed polyol in the ratios (b-TPP:polyol) indicated
*b-TPP: butylated triphenyl phosphate (Phosflex 71B available from Supresta, LLC, a blend comprising about 40% triphenylphosphate (TPP), about 40-46% p-t-butylphenyl diphenylphosphate and about 12-18% bis-(p-t-butylphenyl) phenylphosphate)
**Fyrol ® FR-2: tris dichloro isopropyl phosphate

### Cal 117 Results

The foams of Examples 1, 3-16 passed the Cal 117 test with 20 parts of the butylated triphenyl phosphate/additive blend.

While the above description contains many specifics, these specifics should not be construed as limitations of the invention, but merely as exemplifications of preferred embodiments thereof. Those skilled in the art will envision many other embodiments within the scope and spirit of the invention.

1. A flame-retardant composition for use in polyurethane foams, said flame-retardant composition comprising:
(a) a phosphate ester blend comprising triphenyl phosphate and one or more alkyl-substituted triphenyl phosphates; and
(b) a polyol crosslinking agent soluble in the phosphate ester blend.

2. The flame-retardant compositon of claim 1 wherein said alkyl is C₁ to C₄ alkyl.

3. The flame-retardant composition of claim 1 wherein said phosphate ester blend is butylated triphenyl phosphate.

4. The flame-retardant composition of claim 1 wherein said polyol is a polyester-polyol.

5. The flame-retardant composition of claim 3 wherein said butylated triphenyl phosphate comprises triphenyl phosphate and butyl-substituted triphenyl phosphate.

6. The flame-retardant composition of claim 5 wherein said butyl-substituted triphenyl phosphate comprises a mixture of t-butylphenyl diphenylphosphate and bis-(t-butylphenyl)phenylphosphate.

7. A flame-retarded polyurethane foam comprising a flame-retardant amount of the flame-retardant composition of claim 1.

8. A flame-retarded polyurethane foam comprising a flame-retardant amount of the flame-retardant composition of claim 2.

9. A flame-retarded polyurethane foam comprising a flame-retardant amount of the flame-retardant composition of claim 3.

10. A flame-retarded polyurethane foam comprising a flame-retardant amount of the flame-retardant composition of claim 4.

11. A flame-retarded polyurethane foam comprising a flame-retardant amount of the flame-retardant composition of claim 5.

12. A flame-retarded polyurethane foam comprising a flame-retardant amount of the flame-retardant composition of claim 6.
